(19) United States
(12) Patent Application Publication
(10) Pub. No.: US 2025/0187942 A1
(43) Pub. Date: Jun. 12, 2025

(54) HIGHLY PROCESSABLE LITHIUM CATHODE MATERIAL AND METHOD FOR MAKING

(71) Applicant: TexPower EV Technologies, Inc., Houston, TX (US)

(72) Inventors: Julia Lamb, Haverhill, MA (US); Ryan Pekarek, Houston, TX (US); Wangda Li, Houston, TX (US); Aaron Liu, Houston, TX (US)

(73) Assignee: TexPower EV Technologies, Inc., Houston, TX (US)

(21) Appl. No.: 18/972,514

(22) Filed: Dec. 6, 2024

Related U.S. Application Data
(60) Provisional application No. 63/606,707, filed on Dec. 6, 2023.

(51) Int. Cl. C01G 53/42; H01M 4/02; H01M 4/04; H01M 4/36; H01M 4/525

(52) U.S. Cl. CPC C01G 53/42; H01M 4/0404; H01M 4/0471; H01M 4/366; H01M 4/525; C01P 2002/90; H01M 2004/028

(57) ABSTRACT

Techniques for processing lithium-ion cathode active materials, such as cathode active materials comprising lithium-based materials, such as lithium metal oxide materials (e.g., lithium transition metal oxide materials) are provided. The techniques process the lithium-ion cathode active materials after an initial preparation step to remove residual lithium species, such as lithium hydroxide and/or lithium carbonate, present in the lithium-ion cathode active materials. Cathode materials comprising low residual lithium species are also described, as well as cathodes and batteries comprising such cathode materials.

### CROSS-REFERENCE TO RELATED APPLICATIONS

This application claims priority to and the benefit of U.S. Provisional Patent Application No. 63/606,707, entitled “Highly Processable Lithium Cathode Material And Method For Making,” filed Dec. 6, 2023, the entire disclosure-of which is incorporated by reference herein for all purposes.

### STATEMENT REGARDING FEDERALLY SPONSORED RESEARCH OR DEVELOPMENT

This invention was made with governmental support under Grant #DE-SC0020025 awarded by the Department of Energy (DOE). The government has certain rights in the invention.

### FIELD

This invention is in the field of lithium-ion battery materials. This invention relates generally to techniques for preparing improved cathode active materials by reducing excess residual lithium species.

### BACKGROUND

Conventional lithium-ion batteries generally include a cathode, an anode, and a separator soaked with an electrolyte between them. Current collectors on the cathode side and the anode side are used to conduct electrical current to or from the cathode and the anode, while the electrolyte allows lithium ions to transport between the cathode and the anode. Due to the potentials involved, copper is generally used as an anode current collector and aluminum is generally used as the cathode current collector. Lithium metal oxides or lithium metal phosphates are commonly used as lithium-ion battery cathodes, and graphite is commonly used as lithium-ion battery anodes.

### SUMMARY

The present disclosure provides techniques for processing cathode active materials useful for lithium-ion batteries. For example, the disclosed techniques include processes for preparing cathode active materials for lithium-ion batteries that have low amounts of residual lithium species, such as lithium hydroxide (LiOH) and/or lithium carbonate (Li₂CO₃).

Large amounts of residual lithium species can be undesirable in some cathode active materials. For example, when cathode active materials are used to prepare a cathode, the cathode active material is often mixed with a solvent or carrier to form a slurry that is coated onto a substrate, such as a current collector. The presence of residual lithium can increase the viscosity of the cathode slurry, and in some cases can cause the slurry to form a gel, making coating of the substrate difficult or impractical. A photograph of an example gelled cathode active material slurry is depicted in FIG. 1. Instead of being a slurry, the slurry has formed a very viscous mass, which is not practical to coat onto a current collector according to typical processing and coating techniques. In many cases, high amounts of residual lithium can result in poor cell performance.

Prior to forming the cathode slurry using the cathode active material, the techniques described herein provide for reducing the amounts of residual lithium species present in the cathode active material, such as by using a washing process that removes the residual lithium species while leaving the cathode active material relatively unperturbed.

In a first aspect, methods are provided, such as methods for reducing amounts of residual lithium species in a cathode active material. An example method of this aspect comprises providing a lithium-based cathode material, such as a lithium-based cathode material that comprises a layered oxide cathode material and residual lithium species; exposing the lithium-based cathode material to a liquid, such as where at least a portion of the residual lithium species dissolves in the liquid; separating the lithium-based cathode material from the liquid; drying the lithium-based cathode material; and reheating the lithium-based cathode material to generate a washed cathode material, such as a washed cathode material that has a lower residual lithium species content than the lithium-based cathode material. Techniques described are useful for reducing a variety of residual lithium species from a lithium-based cathode material, such as but not limited to one or more of Li₂CO₃ or LiOH. The separating process may use any desirable techniques. Example separating techniques include, but are not limited to, one or more of a filtration process, a centrifuging process, or a decanting process.

In any examples, the liquid may include, but is not limited to, one or more of water, alcohols, ethers, esters, alkanes, alkenes, arenes, aldehydes, ketones, or carboxylic acids. In some examples, the liquid comprises one or more of water, ethanol, isopropyl alcohol, methanol, butanol, ethylene glycol, triethylene glycol, diethylene glycol, polyethylene glycol, cyclohexane, hexane, ether, glycerol, aqueous sodium chloride, aqueous sodium hydroxide, or aqueous lithium hydroxide. In some examples, the liquid comprises water and ethylene glycol. Optionally, the liquid can have any suitable temperature, for example from about 0° C. to about 200° C. or from about 0° C. to about 70° C., such as from 10° C. to 20° C., from 20° C. to 30° C., from 30° C. to 40° C., from 40° C. to 50° C., from 50° C. to 60° C., from 60° C. to 70° C., from 70° C. to 80° C., from 80° C. to 90° C., from 90° C. to 100° C., from 100° C. to 110° C., from 110° C. to 120° C., from 120° C. to 130° C., from 130° C. to 140° C., from 140° C. to 150° C., from 150° C. to 160° C., from 160° C. to 170° C., from 170° C. to 180° C., from 180° C. to 190° C., or from 190° C. to 200° C. Optionally, multiple liquids may be used. For example, the liquid may be a first liquid and the method may further comprises exposing the lithium-based cathode material to a second liquid different from the first liquid to displace at least a portion of the first liquid. Example liquids useful as the second liquid include, but are not limited to, one or more of ethanol, isopropyl alcohol, methanol, butanol, ethylene glycol, triethylene glycol, diethylene glycol, polyethylene glycol, cyclohexane, hexane, ether, glycerol, aqueous sodium chloride, aqueous sodium hydroxide, or aqueous lithium hydroxide. Optionally, the second liquid has a temperature of from about 0° C. to about 200° C. or from about 0° C. to about 70° C., such as from 10° C. to 20° C., from 20° C. to 30° C., from 30° C. to 40° C., from 40° C. to 50° C., from 50° C. to 60° C., from 60° C. to 70° C., from 70° C. to 80° C., from 80° C. to 90° C., from 90° C. to 100° C., from 100° C. to 110° C., from 110° C. to 120° C., from 120° C. to 130° C., from 130° C. to 140° C., from 140° C. to 150° C., from 150° C. to 160° C., from 160° C. to 170° C., from 170° C. to 180° C., from 180° C. to 190° C., or from 190° C. to 200° C. In any examples, during the exposing, the lithium-based cathode material may be exposed to the liquid (e.g., the first liquid and/or the second liquid) for a duration of less than or about 60 minutes, such as 60 minutes or less, 55 minutes or less, 50 minutes or less, 45 minutes or less, 40 minutes or less, 35 minutes or less, 30 minutes or less, 25 minutes or less, 20 minutes or less, 15 minutes or less, 10 minutes or less, 5 minutes or less, 4 minutes or less, 3 minutes or less, 2 minutes or less, 1 minute or less, 45 seconds or less, 30 seconds or less, or 15 seconds or less.

Optionally, drying comprises heating the washed cathode material to a temperature of from about 50° C. to about 500° C., such as for up to about 48 hours. In any examples, drying may comprise heating to a temperature of from 50° C. to 55° C., from 55° C. to 60° C., from 60° C. to 65° C., from 65° C. to 70° C., from 70° C. to 75° C., from 75° C. to 80° C., from 80° C. to 85° C., from 85° C. to 90° C., from 90° C. to 95° C., from 95° C. to 100° C., from 100° C. to 125° C., from 125° C. to 150° C., from 150° C. to 175° C., from 175° C. to 200° C., from 200° C. to 225° C., from 225° C. to 250° C., from 250° C. to 275° C., from 275° C. to 300° C., from 300° C. to 325° C., from 325° C. to 350° C., from 350° C. to 375° C., from 375° C. to 400° C., from 400° C. to 425° C., from 425° C. to 450° C., from 450° C. to 475° C., or from 475° C. to 500° C. In any examples, drying may comprise heating to the selected temperature for a period of time of up to or about 1 hour, up to or about 2 hour, up to or about 3 hours, up to or about 4 hours, up to or about 5 hours, up to or about 10 hours, up to or about 20 hours, up to or about 24 hours, up to or about 30 hours, up to or about 40 hours, or up to or about 48 hours. In any examples, heating takes place under vacuum, in an inert atmosphere, in air, or in oxygen.

Optionally, reheating comprises heating the washed cathode material to a temperature of from about 50° C. to about 900° C., such as for up to about 24 hours. In any examples, reheating may comprise heating to a temperature of from 50° C. to 55° C., from 55° C. to 60° C., from 60° C. to 65° C., from 65° C. to 70° C., from 70° C. to 75° C., from 75° C. to 80° C., from 80° C. to 85° C., from 85° C. to 90° C., from 90° C. to 95° C., from 95° C. to 100° C., from 100° C. to 125° C., from 125° C. to 150° C., from 150° C. to 175° C., from 175° C. to 200° C., from 200° C. to 225° C., from 225° C. to 250° C., from 250° C. to 275° C., from 275° C. to 300° C., from 300° C. to 325° C., from 325° C. to 350° C., from 350° C. to 375° C., from 375° C. to 400° C., from 400° C. to 425° C., from 425° C. to 450° C., from 450° C. to 475° C., from 475° C. to 500° C., from 500° C. to 525° C., from 525° C. to 550° C., from 550° C. to 575° C., from 575° C. to 600° C., from 600° C. to 625° C., from 625° C. to 650° C., from 650° C. to 675° C., from 675° C. to 700° C., from 700° C. to 725° C., from 725° C. to 750° C., from 750° C. to 775° C., from 775° C. to 800° C., from 800° C. to 825° C., from 825° C. to 850° C., from 850° C. to 875° C., or from 875° C. to 900° C. Any suitable heating rate during reheating may be used, such as up to 1° C./min, up to 5° C./min, or up to 10° C./min, to the reheating temperature. In any examples, reheating may comprise heating to the selected temperature for a period of time of up to or about 1 hour, up to or about 2 hour, up to or about 3 hours, up to or about 4 hours, up to or about 5 hours, up to or about 10 hours, up to or about 15 hours, up to or about 20 hours, or up to or about 24 hours. In some examples, the reheating process may occur at or within 50° C. of a calcination temperature originally used in preparing the lithium-based cathode material.

In any examples, reheating takes place in an inert atmosphere, in air, or in oxygen, such as at a pressure of about 1 atm to about 3 atm (e.g., 1 to 1.5 atm, 1.5 to 2 atm, 2 to 2.5 atm, or 2.5 to 3 atm). In any examples, prior to the drying and/or the reheating (e.g., during exposure to the liquid) at least some of surfaces of the layered oxide cathode material is transformed from a first crystal structure to a second crystal structure different from the first crystal structure and during the drying and/or the reheating at least a portion of the second crystal structure is transformed to the first crystal structure.

In some examples, additional lithium species may be added to the lithium-based cathode material after the drying, such as to provide excess lithium to the lithium-based cathode material. For example, methods of this aspect may further comprise mixing the lithium-based cathode material with lithium hydroxide after the drying. In examples, reheating comprises heating the lithium-based cathode material mixed with solid lithium hydroxide to a temperature of from 50° C. to 900° C. in an atmosphere comprising oxygen, which may convert all or a portion of the added lithium hydroxide to another lithium containing species (e.g., lithium oxide, lithium carbonate, or a lithium metal oxide).

In examples, the layered oxide cathode material comprises LiₐNi_{(1-b-c)}CO_{b}M_{c}O_{d}, where M is at least one of: one or more transition metals, one or more post-transition metals, one or more rare earth metals, one or more alkaline earth metals, one or more alkali metals, one or more metalloids, or one or more non-metals, where a is from about 0.9 to about 1.3, where b is from about 0 to about 1, wherein c is from about 0 to about 1, and wherein d is from about 1.9 to about 4.1. In examples, b is less than or about 0.05, less than or about 0.045, less than or about 0.04, less than or about 0.035, less than or about 0.03, less than or about 0.025, less than or about 0.02, less than or about 0.015, less than or about 0.01, less than or about 0.005, less than or about 0.004, less than or about 0.003, less than or about 0.002, less than or about 0.001, about 0, or equal to 0. In examples, a is from about 0.9 to about 0.91, from about 0.91 to about 0.92, from about 0.92 to about 0.93, from about 0.93 to about 0.94, from about 0.94 to about 0.95, from about 0.95 to about 0.96, from about 0.96 to about 0.97, from about 0.97 to about 0.98, from about 0.98 to about 0.99, from about 0.99 to about 1, from about 1 to about 1.01, from about 1.01 to about 1.02, from about 1.02 to about 1.03, from about 1.03 to about 1.04, from about 1.04 to about 1.05, from about 1.05 to about 1.06, from about 1.06 to about 1.07, from about 1.07 to about 1.08, from about 1.08 to about 1.09, from about 1.09 to about 1.1, from about 1.1 to about 1.11, from about 1.11 to about 1.12, from about 1.12 to about 1.13, from about 1.13 to about 1.14, from about 1.14 to about 1.15, from about 1.15 to about 1.16, from about 1.16 to about 1.17, from about 1.17 to about 1.18, from about 1.18 to about 1.19, from about 1.19 to about 1.2, from about 1.21 to about 1.22, from about 1.22 to about 1.23, from about 1.23 to about 1.24, from about 1.24 to about 1.25, from about 1.25 to about 1.26, from about 1.26 to about 1.27, from about 1.27 to about 1.28, from about 1.28 to about 1.29, or from about 1.29 to about 1.3. In examples, c is from about 0 to about 0.01, from about 0.01 to about 0.02, from about 0.02 to about 0.03, from about 0.03 to about 0.04, from about 0.04 to about 0.05, from about 0.05 to about 0.06, from about 0.06 to about 0.07, from about 0.07 to about 0.08, from about 0.08 to about 0.09, from about 0.09 to about 0.1, from about 0.1 to about 0.11, from about 0.11 to about 0.12, from about 0.12 to about 0.13, from about 0.13 to about 0.14, from about 0.14 to about 0.15, from about 0.15 to about 0.16, from about 0.16 to about 0.17, from about 0.17 to about 0.18, from about 0.18 to about 0.19, from about 0.19 to about 0.2, from about 0.21 to about 0.22, from about 0.22 to about 0.23, from about 0.23 to about 0.24, from about 0.24 to about 0.25, from about 0.25 to about 0.26, from about 0.26 to about 0.27, from about 0.27 to about 0.28, from about 0.28 to about 0.29, from about 0.29 to about 0.3, from about 0.3 to about 0.31, from about 0.31 to about 0.32, from about 0.32 to about 0.33, from about 0.33 to about 0.34, from about 0.34 to about 0.35, from about 0.35 to about 0.36, from about 0.36 to about 0.37, from about 0.37 to about 0.38, from about 0.38 to about 0.39, from about 0.39 to about 0.4, from about 0.4 to about 0.41, from about 0.41 to about 0.42, from about 0.42 to about 0.43, from about 0.43 to about 0.44, from about 0.44 to about 0.45, from about 0.45 to about 0.46, from about 0.46 to about 0.47, from about 0.47 to about 0.48, from about 0.48 to about 0.49, from about 0.49 to about 0.5, from about 0.51 to about 0.52, from about 0.52 to about 0.53, from about 0.53 to about 0.54, from about 0.54 to about 0.55, from about 0.55 to about 0.56, from about 0.56 to about 0.57, from about 0.57 to about 0.58, from about 0.58 to about 0.59, from about 0.29 to about 0.6, from about 0.6 to about 0.61, from about 0.61 to about 0.62, from about 0.62 to about 0.63, from about 0.63 to about 0.64, from about 0.64 to about 0.65, from about 0.65 to about 0.66, from about 0.66 to about 0.67, from about 0.67 to about 0.68, from about 0.68 to about 0.69, from about 0.69 to about 0.7, from about 0.7 to about 0.71, from about 0.71 to about 0.72, from about 0.72 to about 0.73, from about 0.73 to about 0.74, from about 0.74 to about 0.75, from about 0.75 to about 0.76, from about 0.76 to about 0.77, from about 0.77 to about 0.78, from about 0.78 to about 0.79, from about 0.79 to about 0.8, from about 0.81 to about 0.82, from about 0.82 to about 0.83, from about 0.83 to about 0.84, from about 0.84 to about 0.85, from about 0.85 to about 0.86, from about 0.86 to about 0.87, from about 0.87 to about 0.88, from about 0.88 to about 0.89, from about 0.89 to about 0.9, from about 0.9 to about 0.91, from about 0.91 to about 0.92, from about 0.92 to about 0.93, from about 0.93 to about 0.94, from about 0.94 to about 0.95, from about 0.95 to about 0.96, from about 0.96 to about 0.97, from about 0.97 to about 0.98, from about 0.98 to about 0.99, or from about 0.99 to about 1. In examples, d is from about 1.9 to about 4.1, such as from 1.9 to 2, from 2 to 2.1, from 2.1 to 2.2, from 2.2 to 2.3, from 2.3 to 2.4, from 2.4 to 2.5, from 2.5 to 2.6, from 2.6 to 2.7, from 2.7 to 2.8, from 2.8 to 2.9, from 2.9 to 3, from 3 to 3.1, from 3.1 to 3.2, from 3.2 to 3.3, from 3.3 to 3.4, from 3.4 to 3.5, from 3.5 to 3.6, from 3.6 to 3.7, from 3.7 to 3.8, from 3.8 to 3.9, from 3.9 to 4, or from 4 to 4.1.

Optionally, M comprises multiple different elements. For example, M may comprise M1 and M2, where M1 and M2 are different and together correspond to M. In such examples, the layered oxide cathode material comprises LiₐNi_{(1-b-c)}Co_{b}M1_{c1}M2_{c2}O_{d}, such as where c1 and c2 total to c. Optionally, M comprises one or more of Al, Mn Mg, Fe, Cr, B, Ti, Zr, Ga, Zn, V, Cu, Yb, Li, Na, K, F, Ba, Ca, Lu, Y, Nb, Mo, Ru, Rh, Ta, Pr, W, Ir, In, Sn, Sr, S, P, Cl, Ge, Sb, Er, Te, La, Ce, Nd, Dy, Eu, Sc, Se, Si, Tc, Pd, Pm, Sm, Gd, Tb, Ho, or Tm. In some examples, M comprises one or more of Mn, Mg, or Al.

In examples, the methods of this aspect are able to achieve a significant reduction in residual lithium species. For example, the residual lithium species may comprise up to or about 5000 ppm of the lithium-based cathode material prior to the method, such as up to or about 4500 ppm, up to or about 4000 ppm, up to or about 3500 ppm, up to or about 3000 ppm, up to or about 2500 ppm, up to or about 2000 ppm, up to or about 1500 ppm, or up to or about 1000 ppm. In some examples, the residual lithium species in the washed cathode material comprises less than or about 1000 ppm of the washed cathode material, such as less than or about 1000 ppm, less than or about 950 ppm, less than or about 1000 ppm, less than or about 950 ppm, less than or about 900 ppm, less than or about 850 ppm, less than or about 800 ppm, less than or about 750 ppm, less than or about 700 ppm, less than or about 650 ppm, less than or about 600 ppm, less than or about 550 ppm, less than or about 500 ppm, less than or about 450 ppm, less than or about 400 ppm, less than or about 350 ppm, less than or about 300 ppm, less than or about 250 ppm, less than or about 200 ppm, less than or about 150 ppm, less than or about 100 ppm, less than or about 50 ppm, less than or about 50 ppm, less than or about 50 ppm, less than or about 40 ppm, less than or about 30 ppm, less than or about 20 ppm, less than or about 10 ppm, or less than or about 5 ppm. In examples, the exposing, separating, and drying removes about 10% to about 100% of the residual lithium species from the lithium-based cathode material, such as from 10% to 11%, from 11% to 12%, from 12% to 13%, from 13% to 14%, from 14% to 15%, from 15% to 16%, from 16% to 17%, from 17% to 18%, from 18% to 19%, from 19% to 20%, from 20% to 21%, from 21% to 22%, from 22% to 23%, from 23% to 24%, from 24% to 25%, from 25% to 26%, from 26% to 27%, from 27% to 28%, from 28% to 29%, from 29% to 30%, from 30% to 31%, from 31% to 32%, from 32% to 33%, from 33% to 34%, from 34% to 35%, from 35% to 36%, from 36% to 37%, from 37% to 38%, from 38% to 39%, from 39% to 40%, from 40% to 41%, from 41% to 42%, from 42% to 43%, from 43% to 44%, from 44% to 45%, from 45% to 46%, from 46% to 47%, from 47% to 48%, from 48% to 49%, from 49% to 50%, from 50% to 51%, from 51% to 52%, from 52% to 13%, from 53% to 54%, from 54% to 55%, from 55% to 56%, from 56% to 57%, from 57% to 18%, from 58% to 59%, from 59% to 60%, from 60% to 61%, from 61% to 62%, from 62% to 63%, from 63% to 64%, from 64% to 65%, from 65% to 66%, from 66% to 67%, from 67% to 68%, from 68% to 69%, from 69% to 70%, from 70% to 71%, from 71% to 72%, from 72% to 73%, from 73% to 74%, from 74% to 75%, from 75% to 76%, from 76% to 77%, from 77% to 78%, from 78% to 79%, from 79% to 80%, from 80% to 81%, from 81% to 82%, from 82% to 83%, from 83% to 84%, from 84% to 85%, from 85% to 86%, from 86% to 87%, from 87% to 88%, from 88% to 89%, from 89% to 90%, from 90% to 91%, from 91% to 92%, from 92% to 93%, from 93% to 94%, from 94% to 95%, from 95% to 96%, from 96% to 97%, from 97% to 98%, from 98% to 99%, or from 99% to 100%.

The methods of this aspect may result in the washed lithium-based cathode material exhibiting superior properties as compared to the lithium-based cathode material prior to being subjected to the methods described herein. Optionally, the washed cathode material may exhibit a higher density or tap density than the lithium-based cathode material. Optionally, the washed cathode material may exhibit a higher capacity than the lithium-based cathode material. Optionally, the washed cathode material may exhibit a higher lithiation capacity or delithiation capacity than the lithium-based cathode material. Optionally, the washed cathode material may exhibit a higher rate capability than the lithium-based cathode material, measured by the percent of capacity retention between a high-current cycle relative to a low-current cycle. Optionally, the washed cathode material may exhibit a higher first-cycle coulombic efficiency than the lithium-based cathode material.

Methods of this aspect may include further steps, such as to allow generation of a lithium-ion cathode and/or lithium-ion battery using the washed lithium-based cathode material. In some examples, methods of this aspect may further comprise mixing the washed cathode material with one or more of a solvent, a binder, a conductive additive to generate a cathode slurry. Useful solvents include, but are not limited to, N-methyl-2-pyrrolidone (NMP) or dimethylformamide (DMF). Useful binders include, but are not limited to one or more of polyvinylidene fluoride (PVDF), poly (3,4-ethylenedioxythiophene) (PEDOT), poly (styrene sulfonate) (PSS), or sodium carboxymethyl cellulose (CMC). Useful conductive additive include, but are not limited to, one or more of a carbon allotrope, carbon black, carbon nanotubes, carbon fibers, graphite, or another carbonaceous material.

Again, the use of the washed lithium-based cathode material with a reduced residual lithium species may be beneficial for making cathode slurries. In some examples, the slurry formed according to the methods described herein may have a lower viscosity than a comparable slurry comprising the lithium-based cathode (e.g., prior to washing and/or having more residual lithium species than the washed lithium-based cathode material), the solvent, the binder, and the conductive additive. For example, the comparable slurry may be at identical temperature and atmospheric conditions and include equal concentrations or amounts of the solvent, the binder, and the conductive additive as the slurry, and the comparable slurry may include a concentration or amount of the washed cathode material equal to a concentration or amount of the lithium-based cathode material in the slurry. In some embodiments, the washed lithium-based cathode material may exhibit a viscosity of less than about 500 Pa·s when measured at a shear rate of 1 ·s⁻¹ and a solids content of 60%.

Methods of this aspect may optionally further comprise coating the cathode slurry on a cathode current collector; and evaporating at least a portion of the solvent from the cathode slurry coated on the cathode current collector to form a cathode. Methods of this aspect may optionally further comprise providing an anode; and positioning an electrolyte between the cathode and the anode to form a battery. The slurry formed with the use of the washed lithium-based cathode material with a reduced residual lithium species may allow for thicker or denser cathodes after coating and drying onto the current collector. Without being bound by any theory, lower viscosity may mean the slurries can achieve a higher mass to solvent ratio in the slurry, allowing for a thicker (and optionally denser) coating onto the current collector.

In another aspect, provided are cathode materials, such as cathode active materials for a lithium-ion battery. An example cathode material of this aspect comprises LiₐNi_{(1-b-c)}Co_{b}M_{c}O_{d}, and one or more residual lithium species, where the one or more residual lithium species are present in the cathode material at a concentration of less than or about 2000 ppm. In examples, M is at least one of: one or more transition metals, one or more post-transition metals, one or more rare earth metals, one or more alkaline earth metals, one or more alkali metals, one or more metalloids, or one or more non-metals, a is from about 0.9 to 1.3, b is from 0 to 1, c is from 0 to 1, and d is from 1.9 to 4.1. Optionally, the concentration of the one or more residual lithium species in the cathode material is less than or about 1900 ppm, less than or about 1800 ppm, less than or about 1700 ppm, less than or about 1600 ppm, less than or about 1500 ppm, less than or about 1400 ppm, less than or about 1300 ppm, less than or about 1200 ppm, less than or about 1100 ppm, less than or about 1000 ppm, less than or about 900 ppm, less than or about 800 ppm, less than or about 700 ppm, less than or about 600 ppm, less than or about 500 ppm, less than or about 400 ppm, less than or about 300 ppm, less than or about 200 ppm, less than or about 100 ppm, less than or about 90 ppm, less than or about 80 ppm, less than or about 70 ppm, less than or about 60 ppm, less than or about 50 ppm, less than or about 40 ppm, less than or about 30 ppm, less than or about 20 ppm, or less than or about 10 ppm.

In examples, b is less than or about 0.05, less than or about 0.045, less than or about 0.04, less than or about 0.035, less than or about 0.03, less than or about 0.025, less than or about 0.02, less than or about 0.015, less than or about 0.01, less than or about 0.005, less than or about 0.004, less than or about 0.003, less than or about 0.002, less than or about 0.001, about 0, or equal to 0. In examples, a is from about 0.9 to about 0.91, from about 0.91 to about 0.92, from about 0.92 to about 0.93, from about 0.93 to about 0.94, from about 0.94 to about 0.95, from about 0.95 to about 0.96, from about 0.96 to about 0.97, from about 0.97 to about 0.98, from about 0.98 to about 0.99, from about 0.99 to about 1, from about 1 to about 1.01, from about 1.01 to about 1.02, from about 1.02 to about 1.03, from about 1.03 to about 1.04, from about 1.04 to about 1.05, from about 1.05 to about 1.06, from about 1.06 to about 1.07, from about 1.07 to about 1.08, from about 1.08 to about 1.09, from about 1.09 to about 1.1, from about 1.1 to about 1.11, from about 1.11 to about 1.12, from about 1.12 to about 1.13, from about 1.13 to about 1.14, from about 1.14 to about 1.15, from about 1.15 to about 1.16, from about 1.16 to about 1.17, from about 1.17 to about 1.18, from about 1.18 to about 1.19, from about 1.19 to about 1.2, from about 1.21 to about 1.22, from about 1.22 to about 1.23, from about 1.23 to about 1.24,from about 1.24 to about 1.25, from about 1.25 to about 1.26, from about 1.26 to about 1.27,from about 1.27 to about 1.28, from about 1.28 to about 1.29, or from about 1.29 to about 1.3. In examples, c is from about 0 to about 0.01, from about 0.01 to about 0.02, from about 0.02 to about 0.03, from about 0.03 to about 0.04, from about 0.04 to about 0.05, from about 0.05 to about 0.06, from about 0.06 to about 0.07, from about 0.07 to about 0.08, from about 0.08 to about 0.09, from about 0.09 to about 0.1, from about 0.1 to about 0.11, from about 0.11 to about 0.12, from about 0.12 to about 0.13, from about 0.13 to about 0.14, from about 0.14 to about 0.15, from about 0.15 to about 0.16, from about 0.16 to about 0.17, from about 0.17 to about 0.18, from about 0.18 to about 0.19, from about 0.19 to about 0.2, from about 0.21 to about 0.22, from about 0.22 to about 0.23, from about 0.23 to about 0.24, from about 0.24 to about 0.25,from about 0.25 to about 0.26, from about 0.26 to about 0.27, from about 0.27 to about 0.28,from about 0.28 to about 0.29, from about 0.29 to about 0.3, from about 0.3 to about 0.31, from about 0.31 to about 0.32, from about 0.32 to about 0.33, from about 0.33 to about 0.34, from about 0.34 to about 0.35, from about 0.35 to about 0.36, from about 0.36 to about 0.37, from about 0.37 to about 0.38, from about 0.38 to about 0.39, from about 0.39 to about 0.4, from about 0.4 to about 0.41, from about 0.41 to about 0.42, from about 0.42 to about 0.43, from about 0.43 to about 0.44, from about 0.44 to about 0.45, from about 0.45 to about 0.46, from about 0.46 to about 0.47, from about 0.47 to about 0.48, from about 0.48 to about 0.49, from about 0.49 to about 0.5, from about 0.51 to about 0.52, from about 0.52 to about 0.53, from about 0.53 to about 0.54, from about 0.54 to about 0.55, from about 0.55 to about 0.56, from about 0.56 to about 0.57, from about 0.57 to about 0.58, from about 0.58 to about 0.59, from about 0.29 to about 0.6, from about 0.6 to about 0.61, from about 0.61 to about 0.62, from about 0.62 to about 0.63, from about 0.63 to about 0.64, from about 0.64 to about 0.65, from about 0.65 to about 0.66, from about 0.66 to about 0.67, from about 0.67 to about 0.68, from about 0.68 to about 0.69, from about 0.69 to about 0.7, from about 0.7 to about 0.71, from about 0.71 to about 0.72, from about 0.72 to about 0.73, from about 0.73 to about 0.74, from about 0.74 to about 0.75, from about 0.75 to about 0.76, from about 0.76 to about 0.77, from about 0.77 to about 0.78, from about 0.78 to about 0.79, from about 0.79 to about 0.8, from about 0.81 to about 0.82, from about 0.82 to about 0.83, from about 0.83 to about 0.84, from about 0.84 to about 0.85, from about 0.85 to about 0.86, from about 0.86 to about 0.87, from about 0.87 to about 0.88, from about 0.88 to about 0.89, from about 0.89 to about 0.9, from about 0.9 to about 0.91, from about 0.91 to about 0.92, from about 0.92 to about 0.93, from about 0.93 to about 0.94, from about 0.94 to about 0.95, from about 0.95 to about 0.96, from about 0.96 to about 0.97, from about 0.97 to about 0.98, from about 0.98 to about 0.99, or from about 0.99 to about 1. In examples, d is from about 1.9 to about 4.1, such as from 1.9 to 2, from 2 to 2.1, from 2.1 to 2.2, from 2.2 to 2.3, from 2.3 to 2.4, from 2.4 to 2.5, from 2.5 to 2.6, from 2.6 to 2.7, from 2.7 to 2.8, from 2.8 to 2.9, from 2.9 to 3, from 3 to 3.1, from 3.1 to 3.2, from 3.2 to 3.3, from 3.3 to 3.4, from 3.4 to 3.5, from 3.5 to 3.6, from 3.6 to 3.7, from 3.7 to 3.8, from 3.8 to 3.9, from 3.9 to 4, or from 4 to 4.1.

Optionally, M comprises multiple different elements. For example, M may comprise M1 and M2, where M1 and M2 are different and together correspond to M. In such examples, the layered oxide cathode material comprises LiₐNi_{(1-b-c)}Co_{b}M1_{c1}M2_{c2}O_{d}, such as where c1 and c2 total to c. Optionally, M comprises one or more of Al, Mn Mg, Fe, Cr, B, Ti, Zr, Ga, Zn, V, Cu, Yb, Li, Na, K, F, Ba, Ca, Lu, Y, Nb, Mo, Ru, Rh, Ta, Pr, W, Ir, In, Sn, Sr, S, P, Cl, Ge, Sb, Er, Te, La, Ce, Nd, Dy, Eu, Sc, Se, Si, Tc, Pd, Pm, Sm, Gd, Tb, Ho, or Tm. In some examples, M comprises one or more of Mn, Mg, Al, or Ti.

Cathode materials of this aspect may be prepared according to any suitable method described herein.

In another aspect, cathodes are provided. An example cathode of this aspect comprises a cathode active layer comprising any of the cathode materials described herein; and a cathode current collector in electrical communication with the cathode active layer. Optionally, the cathode material comprises from about 80 to about 98 wt. % of the cathode active layer, such as from 80% to 81%, from 81% to 82%, from 82% to 83%, from 83% to 84%, from 84% to 85%, from 85% to 86%, from 86% to 87%, from 87% to 88%, from 88% to 89%, from 89% to 90%, from 90% to 91%, from 91% to 92%, from 92% to 93%, from 93% to 94%, from 94% to 95%, from 95% to 96%, from 96% to 97%, from 97% to 98%. Optionally, the cathode active layer may further comprise one or more of a binder or a conductive additive mixed with the cathode material. In examples, the binder may comprise from about 2 wt. % to about 10 wt. % of the cathode active layer, such as from 2% to 3%, from 3% to 4%, from 4% to 5%, from 5% to 6%, from 6% to 7%, from 7% to 8%, from 8% to 9%, or from 9% to 10%. In examples, the conductive additive may comprise from about 2 wt. % to 10 wt. % of the cathode active layer, such as from 2% to 3%, from 3% to 4%, from 4% to 5%, from 5% to 6%, from 6% to 7%, from 7% to 8%, from 8% to 9%, or from 9% to 10%.

Without wishing to be bound by any particular theory, there can be discussion herein of beliefs or understandings of underlying principles relating to the invention. It is recognized that regardless of the ultimate correctness of any mechanistic explanation or hypothesis, an embodiment of the invention can nonetheless be operative and useful.

### BRIEF DESCRIPTION OF THE DRAWINGS

FIG. 1 provides a photograph of a gelled cathode active material slurry containing relatively large amounts of residual lithium species.

FIG. 2 provides an overview of a process for reducing residual lithium species in a cathode active material in accordance with some examples described herein.

FIG. 3 provides an overview of a process for preparing a lithium-ion battery using a cathode active material with low residual lithium species in accordance with some examples described herein.

### DETAILED DESCRIPTION

Described herein are techniques for processing lithium-ion cathode active materials, such as cathode active materials comprising lithium-based materials, such as lithium metal oxide materials (e.g., lithium transition metal oxide materials). The disclosed techniques process the lithium-ion cathode active materials after an initial preparation step to remove residual lithium species, such as lithium hydroxide and/or lithium carbonate, present in the lithium-ion cathode active materials. In some examples, the presence of relatively large amounts of residual lithium species in a lithium-ion cathode active material can result in various undesirable effects when using that cathode active material.

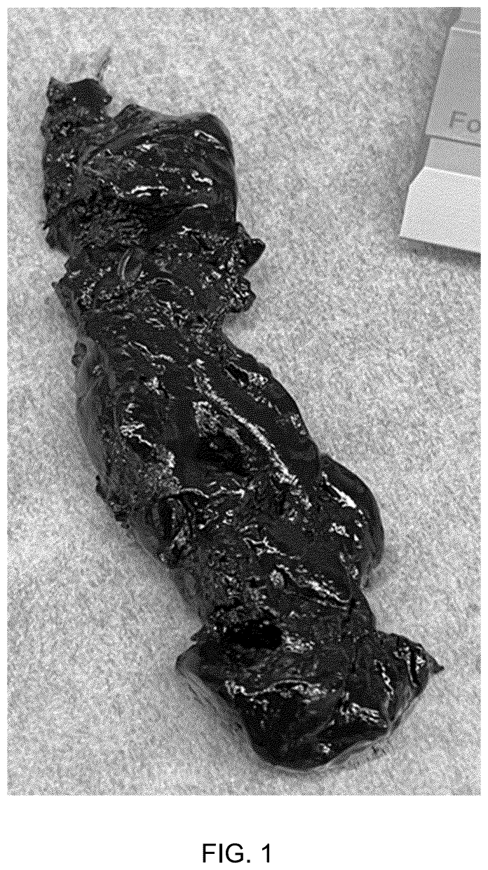

For example, when lithium hydroxide and/or lithium carbonate are present in a cathode active material in undesirable amounts, the cathode active material can be difficult to process into a cathode. In some examples, cathode active materials are formed into a slurry prior to coating onto a cathode current collector to form a cathode. When excessive amounts of residual lithium are present in the cathode active materials this can result in gelation of the slurry, where the slurry becomes a gel or its viscosity increases to a point where it is difficult or impractical to coat the slurry onto the cathode current collector. FIG. 1 shows a photograph of an example gelled cathode active material slurry, where the cathode active material included about 5200 ppm of residual lithium. Even where it is possible to coat the slurry on a cathode current collector, the presence of excessive amounts of residual lithium species can decrease the electrochemical performance of the cathode, such as where the cycle life, capacity, rate capability, first cycle columbic efficiency, or the like are degraded by the presence of excessive amounts of residual lithium species.

To reduce and overcome these issues and provide cathodes with good electrochemical performance, techniques are provided for processing lithium-ion cathode active materials to decrease the presence of residual lithium species in the material. In examples, lithium-ion cathode active materials are subjected to a washing process to reduce the amount of residual lithium species. In a specific example, a lithium-ion cathode active material is exposed to a liquid, such as a liquid that can dissolve the residual lithium species but that does not otherwise dissolve or substantially affect the lithium-ion cathode active material itself, followed by separating the lithium-ion cathode active material from the liquid, and subjecting the lithium-ion cathode active material to a drying process.

In general the terms and phrases used herein have their art-recognized meaning, which can be found by reference to standard texts, journal references and contexts known to those skilled in the art. The following definitions are provided to clarify their specific use in the context of the invention.

“Lithium-based cathode material” refers to a material comprising lithium and other elements that is useful as a cathode active material in a lithium-ion battery. Lithium-based cathode materials include discharged cathode active materials including electrochemically active lithium that can be electrochemically transferred to an anode during a charging process by application of a voltage between the cathode and the anode. Lithium-based cathode materials include lithium transition metal oxides, lithium transition metal phosphates. Lithium-based cathode materials include layered oxide cathode materials, such as having a general formula LiMO₂, where M is one or more metals (e.g., one or more transition metals, post-transition metals, rare earth metals, metalloids, or the like). Layered oxide cathode materials include those comprising LiₐNi_{(1-b-c)}Co_{b}M_{c}O_{d}, where M is at least one of one or more transition metals, one or more post-transition metals, one or more rare earth metals, one or more alkaline earth metals, one or more alkali metals, one or more metalloids, or one or more non-metals, where a is from about 0.9 to 1.3, where b is from 0 to 1, where c is from 0 to 1, and where d is from 1.9 to 4.1. Layered oxide cathode materials include high nickel or nickel-rich materials, such as where 1-b-c in the formula LiₐNi_{(1-b-c)}Co_{b}M_{c}O_{d} is greater than 0.5. Layered oxide cathode materials include low cobalt or cobalt-free materials, such as where b in the formula LiₐNi_{(1-b-c)}Co_{b}M_{c}O_{d} is less than or about 0.05 (e.g., 0.04 or less, 0.03 or less, 0.02 or less, 0.01 or less, or 0). Lithium-based cathode materials include lithium-rich and lithium-deficient materials.

“Residual lithium species” or “residual lithium compounds” refers to lithium-containing compounds that are not incorporated into the active material of a lithium-based cathode material during synthesis or processing of the material. In some examples, residual lithium species are formed after synthesis or processing of the lithium-based cathode material. In some examples, extra lithium source material can be added in a synthesis process, e.g., when preparing Ni-rich layered oxide materials, after the sintering process associated with the synthesis, not all of the lithium source may be incorporated into the desired layered oxide materials, such that some lithium compounds (e.g., lithium oxide, Li₂O) may remain in the material; lithium oxide can react with water (H₂O) or carbon dioxide (CO₂) to form LiOH or Li₂CO₃. In another example, the extra lithium source material may react with impurities or additives during the synthesis process to form undesirable lithium compounds, such as lithium nitrate (LiNO₃), lithium sulfate (Li₂SO₄), or an inactive lithium metal oxide (e.g., LiₐM_{b}O_{c} where M is a metal). These and similar or related lithium-containing compounds may be characterized as residual lithium species or residual lithium compounds. In some cases, residual lithium species, like LiOH or Li₂CO₃, tend to be present at the surface of lithium-based cathode materials since the surface is more likely to be exposed to air than the interior regions of the materials, such that lithium oxide present at the surface of the materials can react with water or carbon dioxide in the air. In some examples, the amounts of residual lithium species present in a lithium-based cathode material can be determined by one or more titration analysis or other techniques. For example, the amount (e.g., ppm) of residual lithium species may be calculated by stirring the lithium-based cathode material in degassed, deionized water at a mass ratio of 1 part cathode to 50 parts water for 10 minutes; the water may then be filtered and titrated. The unit ppm refers to the weight of the residual lithium species relative to the weight of the layered oxide cathode material.

“Drying” refers to removal of a liquid from a mixture, such as by a process of evaporation or sublimation, which may be enhanced by subjecting the mixture to heat, reduced pressure, or flowing gas above or through the mixture. In some cases, the liquid may be a solvent, such as water, ethanol, isopropyl alcohol, methanol, ethylene glycol, or glycerol. In some cases, the liquid may be a mixture or solution, such as including one or more salts that may not be removed by evaporation or sublimation, but which can be displaced by washing or rinsing with a liquid.

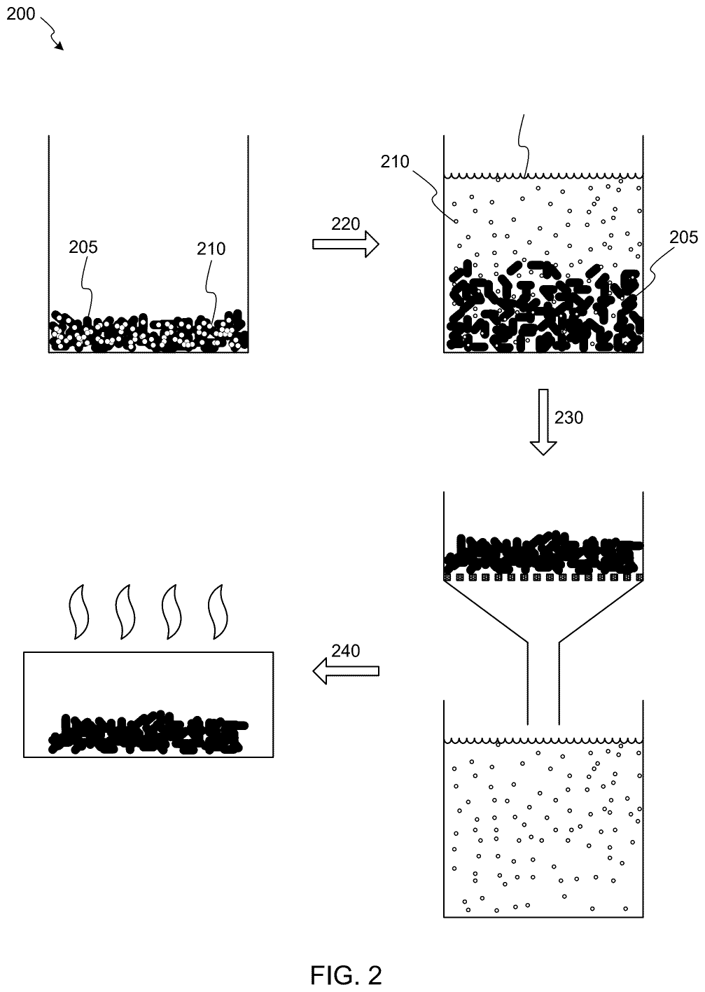

FIG. 2 provides a schematic overview of an example method 100 of processing a cathode active material, such as a lithium-based cathode material to remove residual lithium species. FIG. 2 shows a lithium-based cathode material 205 including residual lithium species 210. The lithium-based cathode material 205 may be any suitable lithium-based cathode active material that includes residual lithium species 210 (e.g., lithium hydroxide or lithium carbonate), such as lithium metal oxides (LMO), which may include one or more transition metals. For example, a lithium metal oxide may have the formula LiₐMₓO_{d}, where a represents the relative amount of Li (lithium) in the lithium metal oxide, M is one or more metals, x represents the relative amount of the one or more metals in the lithium metal oxide, and d represents the relative amount of O (oxygen) in the lithium metal oxide. Nominally a may be 1, x may be 1, and d may be 2, but variations on these are possible, such as where a is from 0.9 to 1.0 or from 1.0 to 1.1, or where d is from 1.9 to 2.0 or from 2.0 to 2.1. The lithium metal oxide material may be prepared using any suitable techniques, such as metal co-precipitation and lithiation calcination processes. Examples of lithium metal oxide preparation methods are described in U.S. Pat. No. 11,233,239, which is hereby incorporated by reference. Where multiple metals are included in the lithium metal oxide material, this may be represented by a formula LiₐM1ₓ₁M2ₓ₂O_{d}, where M1 and M2 are different metals and x1 and x2 total to 1. In some examples, one or more additional metals M3, M4, M5, etc., may be present in a lithium metal oxide, each having a respective subscript (stoichiometry), x3, x4, x5, etc., with all x1, x2, x3, x4, x5, etc. totaling to 1.

In some examples, lithium metal oxides may include amounts of residual lithium species following or upon preparation, such as according to a method including metal co-precipitation and lithiation calcination. In some examples, certain classes of lithium metal oxides may be prone to including high relative amounts of residual lithium species following or upon preparation. For example, lithium metal oxides including relatively large amounts of nickel (Ni), such as having a formula LiₐNi_{b}M_{c}O_{d}, where b is 0.5 to 1 and c is 0, may often be prepared using co-precipitation and lithiation calcination processes and have relatively large amounts of residual lithium. In some examples, the amount of residual lithium 210 in the lithium-based cathode material 205 (e.g., after the co-precipitation and lithiation calcination processes) and/or before any processes for reducing residual lithium content may be greater than or about 1000 ppm, such as greater than or about 1500 ppm, greater than or about 2000 ppm, greater than or about 2500 ppm, greater than or about 3000 ppm, greater than or about 3500 ppm, greater than or about 4000 ppm, greater than or about 4500 ppm, greater than or about 5000 ppm, or greater than or about 5500 ppm, such as up to 7500 ppm.

At 220, the lithium-based cathode material 205 including residual lithium species 210 is exposed to a liquid 215, where at least a portion of the residual lithium species 210 is dissolved in the liquid. Without limitation, liquid 215 may comprise any suitable solvent that is capable of dissolving residual lithium species, like lithium hydroxide or lithium carbonate, such as water, ethanol, isopropyl alcohol, methanol, ethylene glycol, glycerol, or the like. Optionally, the liquid 215 comprises a polar solvent. Optionally, the liquid 215 may include one or more salts dissolved therein, such as sodium chloride, sodium hydroxide, or lithium hydroxide. For example, the liquid 215 may comprise an aqueous solution including sodium chloride, sodium hydroxide, or lithium hydroxide. The lithium-based cathode material 205 may be suspended in the liquid, which may be subjected to a stirring or agitation process (e.g., ultrasonic agitation, etc.), such as to increase the dissolution of the residual lithium species. In some examples, it may be desirable to use liquids other than water, which can in some cases pull lithium ions from the bulk of the lithium-based cathode material 205. In other examples, water or mixtures including water can be used. In some cases, the liquid 215 may include a mixture of two or more solvents. In some cases, the liquid 215 may include a mixture of three or more solvents (e.g., up to 4 or 5 solvents). In some examples, using a liquid 215 comprising multiple different solvents may be beneficial for achieving superior removal of residual lithium species 210 from lithium-based cathode material 205.

At 230 the liquid 215, including dissolved residual lithium species 210, is separated from the lithium-based cathode material 205. Various separation processes can be used, such as a centrifuging process, a filtration process (as depicted in FIG. 2), a decanting process, or the like. The lithium-based cathode material 205 can be optionally exposed to a second liquid and optionally subjected to a second separation process. For example, the lithium-based cathode material 205 may be rinsed with a second liquid. Optionally, the lithium-based cathode material 205 may be suspended in the second liquid and optionally subjected to a stirring or agitation process prior to a further separation process.

Once the liquid 215 is separated from the lithium-based cathode material 205, the lithium-based cathode material 205 can be subjected, at 240, to a drying process. For example, lithium-based cathode material 205 can be placed into an oven (as depicted in FIG. 2) or other system to drive or aid in removing any remaining liquid 215 from the lithium-based cathode material 205, such as by a process of evaporation. The drying process can optionally include flowing a gas past, through, or over the lithium-based cathode material 205 or processing the lithium-based cathode material 205 in a vacuum or reduced pressure environment. In some examples, the gas comprises air, oxygen, carbon dioxide, nitrogen, argon or the like. Optionally, the drying process comprises heating the lithium-based cathode material 205 in the presence of a reactive or non-reactive gas. Optionally, the gas may be oxygen, where lithium-based cathode material 205 is heated in oxygen to drive an oxidation or calcination process. After the drying process, the washed lithium-based cathode material 225 can subjected to further processing. For example, the washed lithium-based cathode material 225 may optionally be subjected to a reheating step after the drying process, such as to a temperature of up to or about 700° C. in oxygen.

In some examples, the amount of residual lithium 210 in washed lithium-based cathode material 225 after the drying process may be less than or about 1500 ppm, such as less than or about 1400 ppm, less than or about 1300 ppm, less than or about 1200 ppm, less than or about 1100 ppm, less than or about 1000 ppm, less than or about 900 ppm, less than or about 800 ppm, less than or about 700 ppm, less than or about 600 ppm, less than or about 500 ppm, less than or about 400 ppm, less than or about 300 ppm, less than or about 200 ppm, less than or about 100 ppm, or less than or about 50 ppm. In some examples, the amount of residual lithium 210 in washed lithium-based cathode material 225 may be a fraction or partial of the amount of residual lithium 210 in lithium-based cathode material 205, such as where the amount of residual lithium 210 in washed lithium-based cathode material 225 is less than or about 90%, less than or about 80%, less than or about 70%, less than or about 60%, less than or about 50%, less than or about 40%, less than or about 30%, less than or about 20%, less than or about 10%, less than or about 5%, less than or about 4%, less than or about 3%, less than or about 2%, or less than or about 1% of the amount of residual lithium 210 in lithium-based cathode material 205.

In some examples, the washed lithium-based cathode material 225 after the drying process may exhibit a changed surface area, porosity, true density, or tap density because of the loss of the residual lithium species and modification of the crystal structure. In some examples, the surface area of the washed lithium-based cathode materials is from about 0.1 m²·g⁻¹ to about 0.3 m²·g⁻¹. In some examples, the washed lithium-based cathode materials may exhibit a porosity from about 15% porosity to about 0% porosity. In some examples, the washed lithium-based cathode materials may exhibit a true density of from about 4 g·cm⁻³ to about 4.75 g·cm⁻³. In some examples, the washed lithium-based cathode materials may exhibit a tap density of from about 2.5 g·cm⁻³ to about 4 g·cm⁻³.

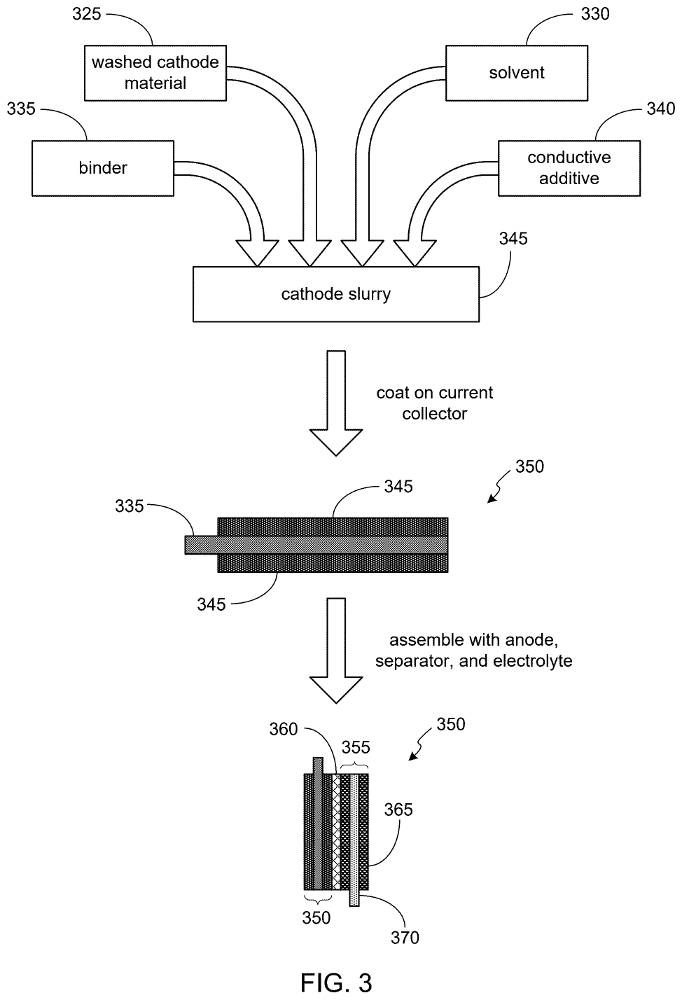

FIG. 3 provides a schematic overview of processing a washed lithium-based cathode material 325 into a cathode 350. Washed lithium-based cathode material 325 may be the same as or different from washed lithium-based cathode material 225. For this process, the washed cathode material 325 may be combined with a solvent 330 to form a cathode slurry 345. Example solvents useful for generating the cathode slurry 345 include, but are not limited to, N-methyl-2-pyrrolidone (NMP), dimethylformamide (DMF). Optionally, other materials may be included in the cathode slurry, such as a binder 335 and/or a conductive additive 340. Examples of binder 335 include, but are not limited to, polyvinylidene fluoride (PVDF), poly (3,4-ethylenedioxythiophene) (PEDOT), poly (styrene sulfonate) (PSS). Examples of conductive additive 340 include, but are not limited to, a carbon allotrope, carbon black, carbon nanotubes, carbon fibers, graphite.

The cathode slurry 345 may be coated onto a cathode current collector 355 (e.g., comprising aluminum foil) to form cathode 350. In examples, the coating process may use any suitable process, including drop casting, spin coating, doctor blading, or roll-to-roll processing. Optionally, the cathode slurry may be subjected to a curing process (e.g., by heating to a temperature above ambient temperature).

The cathode 350 can then be assembled into a lithium-ion battery 370, such as by pairing with an anode 355 and an electrolyte 360 (e.g., a solid electrolyte or a separator soaked with a liquid electrolyte). In some examples, the anode 355 may comprise graphite as an anode active material 365 coated onto an anode current collector 370 (e.g., comprising copper foil).

It will be appreciated that the example materials provided with respect to description of the lithium-ion battery are not intended to be limiting and that any other suitable materials for solvent 330, binder 335, conductive additive 340, cathode current collector 335, anode 355, electrolyte 360, anode active material 365, and anode current collector 370 may be used.

In some examples, the lithium-ion battery 370 may be constructed in any suitable form, such as a cylindrical or spiral wound configuration, a prismatic or pouch configuration, a coin-cell configuration, etc.

The invention may be further understood by the following non-limiting examples.

### Example 1: Process for Washing Lithium Metal Oxide Material to Reduce Residual Lithium Species

A mass of calcined lithium metal oxide material to be washed is initially placed into a container. A water and ethylene glycol solution is prepared using a 4:1 volume ratio of ethylene glycol to water. The ethylene glycol and water mixture is added to the container, and the calcined material is mixed with the ethylene glycol and water mixture for a period of time (e.g., one minute).

Following this, the mixture is poured into a vacuum filter apparatus, such as where a paper filter is used to collect the solid material while allowing the liquid to be removed. The solid material in the vacuum filter apparatus is then rinsed using ethanol.

After the liquids (water and ethylene glycol mixture and ethanol) have gone through the filter the solid material is collected and placed into another container. The container is transferred to a vacuum oven and heated to temperature of about 100° C. under vacuum until the solid material is completely dry. The dried material is then placed in an oven and reheated to about 700° C. under oxygen. The dried and heated material is then collected for use as a lithium metal oxide cathode active material.

### REFERENCES

U.S. Pat. No. 11,233,239.
Bauer et al., 2015, “Influence of dry mixing and distribution of conductive additives in cathodes for lithium ion batteries,” J. Power Sources 288, 359-367, DOI: 10.1016/j.jpowsour.2015.04.081
Kato et al., 2022, “Investigation of Water-Washing Effect on Electrochemical Properties of Ni-Rich NCA Cathode Material for Lithium-Ion Batteries,” J. Electrochem. Soc., 169, 060543, DOI: 10.1149/1945/7111/ac79d6
Lee et al., 2022, “Improving high-temperature cycle stability and rate performance of LiNi_{0.82}Co_{0.11}Mn_{0.07}O₂ cathode materials using hydrogen peroxide solution washing System,” J. New Mat. for Electrochem. Systems, 25:2, 98-102, DOI: 10.14447/jnmes.v2512.a02
Lin et al., 2021, “An Effective Way of Improving the Performance of Ni-Rich LiNi_{0.82}Co_{0.12}Mn_{0.06}O₂ Cathode in Lithium-Ion Battery via Borate Coating,” Energy Technology 9, 2000721, DOI: 10.1002/ente.202000721
Liu et al., 2021, “Enhanced Electrochemical Performance of Ni-Rich Cathodes by Neutralizing Residual Lithium with Acid Compounds,” ACS Appl. Mater. Interfaces, 13, 55072-55079, DOI: 10.1021/acsami.1c16482
Nguyen et al., 2020, “Review—Conducting Polymer-Based Binders for Lithium-Ion Batteries and Beyond,” J. Electrochem. Soc., 167, 065501, DOI: 10.1149/1945-7111/ab856b
Park et al., 2018, “Effect of Residual Lithium Rearrangement on Ni-Rich Layered Oxide Cathodes for Lithium-Ion Batteries,” Energy Technol. 6, 1361-1369, DOI: 10.1002/ente.201700950
Park et al., 2018, “Requirement of high lithium content in Ni-rich layered oxide material for Li ion batteries,” J. Alloys and Compounds, 766, 470-476, DOI: 10.1016/j.jallcom.2018.06.135
Seong et al., 2020, “Impact of Residual Lithium on the Adoption of High-Nickel Layered Oxide Cathodes for Lithium-Ion Batteries,” Chemistry of Materials 32 (22), 9479-9489, DOI: 10.1021/acs.chemmater.0c02808
Sliz et al., 2022, “Suitable Cathode NMP Replacement for Efficient Sustainable Printed Li-Ion Batteries,” ACS Appl. Energy Mater., 5, 4047-4058, DOI: 10.1021/acsaem.1c02923
Su et al., 2020, “Clean the Ni-Rich Cathode Material Surface with Boric Acid to Improve its Storage Performance,” Frontiers in Chemistry 8:573, DOI: 10.3389/fchem.2020.00573
Tan et al., 2022, “A scalable dry chemical method for lithium borate coating to improve the performance of LiNi_{0.90}Co_{0.06}Mn_{0.04}O₂ cathode material,” Ionics 28:2073-2082, DOI: 10.1007/s11581-022-04484-9
Xu et al., 2017, “A Mild Surface Washing Method Using Protonated Polyaniline for Ni-rich LiNi_{0.8}C_{0.01}Mn_{0.1}O₂ Material of Lithium Ion Batteries, Electrochemica Acta 248, 534-540, DOI: 10.1016/j.electacta.2017-07.169
You et al., 2021, “H₃BO₃ washed LiNi_{0.8}Co_{0.1}Mn_{0.1}O₂ with enhanced electrochemical performance and storage characteristics,” J. Power Sources, 482, 228940, DOI: 10.1016/j.jpowsour.2020.228940

### STATEMENTS REGARDING INCORPORATION BY REFERENCE AND VARIATIONS

All references throughout this application, for example patent documents, including issued or granted patents or equivalents and patent application publications, and non-patent literature documents or other source material are hereby incorporated by reference herein in their entireties, as though individually incorporated by reference.

All patents and publications mentioned in the specification are indicative of the levels of skill of those skilled in the art to which the invention pertains. References cited herein are incorporated by reference herein in their entirety to indicate the state of the art, in some cases as of their filing date, and it is intended that this information can be employed herein, if needed, to exclude (for example, to disclaim) specific embodiments that are in the prior art.

When a group of substituents is disclosed herein, it is understood that all individual members of those groups and all subgroups and classes that can be formed using the substituents are disclosed separately. When a Markush group or other grouping is used herein, all individual members of the group and all combinations and subcombinations possible of the group are intended to be individually included in the disclosure. As used herein, “and/or” means that one, all, or any combination of items in a list separated by “and/or” are included in the list; for example “1, 2 and/or 3” is equivalent to “1, 2, 3, 1 and 2, 1 and 3, 2 and 3, or 1, 2, and 3”.

Every formulation or combination of components described or exemplified can be used to practice the invention, unless otherwise stated. Specific names of materials are intended to be exemplary, as it is known that one of ordinary skill in the art can name the same material differently. It will be appreciated that methods, device elements, starting materials, and synthetic methods other than those specifically exemplified can be employed in the practice of the invention without resort to undue experimentation. All art-known functional equivalents, of any such methods, device elements, starting materials, and synthetic methods are intended to be included in this invention. Whenever a range is given in the specification, for example, a temperature range, a time range, or a composition range, all intermediate ranges and subranges, as well as all individual values included in the ranges given are intended to be included in the disclosure.

As used herein, “comprising” is synonymous with “including,” “containing,” or “characterized by,” and is inclusive or open-ended and does not exclude additional, unrecited elements or method steps. As used herein, “consisting of” excludes any element, step, or ingredient not specified in the claim element. As used herein, “consisting essentially of” does not exclude materials or steps that do not materially affect the basic and novel characteristics of the claim. Any recitation herein of the term “comprising”, particularly in a description of components of a composition, in a description of a method, or in a description of elements of a device, is understood to encompass those compositions, methods, or devices consisting essentially of and consisting of the recited components or elements, optionally in addition to other components or elements. The invention illustratively described herein suitably may be practiced in the absence of any element, elements, limitation, or limitations which is not specifically disclosed herein.

The terms and expressions which have been employed are used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments and optional features, modification and variation of the concepts herein disclosed may be resorted to by those skilled in the art, and that such modifications and variations are considered to be within the scope of this invention as defined by the appended claims.

What is claimed is:

1. A method, comprising:
providing a lithium-based cathode material, wherein the lithium-based cathode material comprises a layered oxide cathode material and residual lithium species;
exposing the lithium-based cathode material to a liquid, wherein at least a portion of the residual lithium species dissolves in the liquid;
separating the lithium-based cathode material from the liquid;
drying the lithium-based cathode material; and
reheating the lithium-based cathode material to generate a washed cathode material, wherein the washed cathode material has a lower residual lithium species content than the lithium-based cathode material.

2. The method of claim 1, wherein the residual lithium species comprises one or more of Li₂CO₃ or LiOH.

3. The method of claim 1, wherein the liquid comprises one or more of water, ethanol, isopropyl alcohol, methanol, butanol, ethylene glycol, triethylene glycol, diethylene glycol, polyethylene glycol, cyclohexane, hexane, diethyl ether, glycerol, aqueous sodium chloride, aqueous sodium hydroxide, aqueous potassium hydroxide, or aqueous lithium hydroxide.

4. The method of claim 1, wherein the liquid has a temperature of from about 0° C. to about 200° C.

5. The method of claim 1, wherein the liquid is a first liquid and wherein the method further comprises exposing the lithium-based cathode material to a second liquid different from the first liquid to displace at least a portion of the first liquid, wherein the second liquid comprises one or more of ethanol, isopropyl alcohol, methanol, butanol, ethylene glycol, triethylene glycol, diethylene glycol, polyethylene glycol, cyclohexane, hexane, diethyl ether, glycerol, aqueous sodium chloride, aqueous sodium hydroxide, aqueous potassium hydroxide, or aqueous lithium hydroxide.

6. The method of claim 1, wherein, during the exposing, the lithium-based cathode material is exposed to the liquid for a duration of less than or about 60 minutes or less than or about 1 minute.

7. The method of claim 1, wherein drying comprises heating the washed cathode material to a temperature of from 50° C. to 500° C. for up to 48 hours.

8. The method of claim 1, wherein the reheating comprises heating the washed cathode material to a temperature of from 50° C. to 900° C. for up to 24 hours.

9. The method of claim 8, wherein prior to the reheating, at least some of the surfaces of the layered oxide cathode material is transformed from a first crystal structure to a second crystal structure different from the first crystal structure, and wherein during the reheating at least a portion of the second crystal structure is transformed either to the first crystal structure or to a third crystal structure.

10. The method of claim 1, further comprising mixing the lithium-based cathode material with lithium hydroxide or lithium carbonate after the drying.

11. The method of claim 10, wherein reheating comprises heating the lithium-based cathode material mixed with solid lithium hydroxide or lithium carbonate to a temperature of from 50° C. to 900° C. in an atmosphere comprising oxygen.

12. The method of claim 1, wherein the layered oxide cathode material comprises LiₐNi_{(1-b-c)}Co_{b}M_{c}O_{d}, wherein M is at least one of: one or more transition metals, one or more post-transition metals, one or more rare earth metals, one or more alkaline earth metals, one or more alkali metals, one or more metalloids, or one or more non-metals, wherein a is from 0.9 to 1.3, wherein b is from 0 to 1, wherein c is from 0 to 1, and wherein d is from 1.9 to 4.1.

13. The method of claim 1, wherein M comprises one or more of Al, Mn, Mg, Fe, Cr, B, Ti, Zr, Ga, Zn, V, Cu, Yb, Li, Na, K, F, Ba, Ca, Lu, Y, Nb, Mo, Ru, Rh, Ta, Pr, W, Ir, In, Sn, Sr, S, P, Cl, Ge, Sb, Er, Te, La, Ce, Nd, Dy, Eu, Sc, Se, Si, Tc, Pd, Pm, Sm, Gd, Tb, Ho, or Tm.

14. The method of claim 1, wherein the lithium-based cathode material comprises less than or about 5000 ppm of residual lithium species.

15. The method of claim 1, wherein the exposing, separating, and drying removes about 10% to about 100% of the residual lithium species from the lithium-based cathode material.

16. The method of claim 1, wherein separating comprises one or more of a filtration process, a centrifuging process, or a decanting process.

17. The method of claim 1, wherein the washed cathode material exhibits an improved property than the lithium-based cathode material, wherein the property comprises a tap density, a lithiation capacity, a delithiation capacity, a rate capability, a first-cycle coulombic efficiency, and a combination thereof.

18. The method of claim 1, further comprising:
mixing the washed cathode material with one or more of a solvent, a binder, a conductive additive to generate a cathode slurry.

19. The method of claim 18, wherein the slurry has a lower viscosity than a comparable slurry comprising the lithium-based cathode the solvent, the binder, and the conductive additive.

20. The method of claim 19, wherein the comparable slurry includes equal concentrations or amounts of the solvent, the binder, and the conductive additive as the slurry, and wherein the comparable slurry includes a concentration or amount of the washed cathode material equal to a concentration or amount of the lithium-based cathode material in the slurry, and wherein the comparable slurry is at identical temperature and atmospheric conditions.

21. The method of claim 18, further comprising:
coating the cathode slurry on a cathode current collector; and
evaporating at least a portion of the solvent from the cathode slurry coated on the cathode current collector to form a cathode.

22. The method of claim 18, further comprising:
providing an anode; and
positioning an electrolyte between the cathode and the anode to form a battery.

23. A cathode material comprising:
LiₐNi_{(1-b-c)}Co_{b}M_{c}O_{d}, wherein M is at least one of: one or more transition metals, one or more post-transition metals, one or more rare earth metals, one or more alkaline earth metals, one or more alkali metals, one or more metalloids, or one or more non-metals, wherein a is from about 0.9 to 1.3, wherein b is from 0 to 1, wherein c is from 0 to 1, and wherein d is from 1.9 to 4.1; and
one or more residual lithium species, wherein the one or more residual lithium species are present in the cathode material at a concentration of less than or about 2000 ppm.

24. The cathode material of claim 23, wherein M comprises one or more of Al, Mn, Mg, Fe, Cr, B, Ti, Zr, Ga, Zn, V, Cu, Yb, Li, Na, K, F, Ba, Ca, Lu, Y, Nb, Mo, Ru, Rh, Ta, Pr, W, Ir, In, Ti, Sn, Sr, S, P, Cl, Ge, Sb, Er, Te, La, Ce, Nd, Dy, Eu, Sc, Se, Si, Tc, Pd, Pm, Sm, Gd, Tb, Ho, or Tm.

25. A cathode, comprising:
a cathode active layer comprising:
LiₐNi_{(1-b-c)}Co_{b}M_{c}O_{d}, wherein M is at least one of: one or more transition metals, one or more post-transition metals, one or more rare earth metals, one or more alkaline earth metals, one or more alkali metals, one or more metalloids, or one or more non-metals, wherein a is from about 0.9 to 1.3, wherein b is from 0 to 1, wherein c is from 0 to 1, and wherein d is from 1.9 to 4.1; and
one or more residual lithium species, wherein the one or more residual lithium species are present in the cathode material at a concentration of less than or about 2000 ppm; and
a cathode current collector in electrical communication with the cathode active layer.

26. The cathode of claim 25, wherein the cathode active layer further comprises one or more of a binder or a conductive additive mixed with the cathode material.

27. The cathode of claim 26, further comprising:
an anode; and
an electrolyte positioned between the cathode and the anode to form a battery.
